(19) United States
(12) Patent Application Publication
(10) Pub. No.: US 2025/0112719 A1
(43) Pub. Date: Apr. 3, 2025

(54) METHOD AND APPARATUS FOR QUIETING TRANSMISSIONS IN A COMMUNICATION NETWORK

(71) Applicant: Marvell Asia Pte Ltd, Singapore (SG)

(72) Inventors: Dance WU, Palo Alto, CA (US); Deepak SABHARWAL, Fremont, CA (US)

(21) Appl. No.: 18/431,788

(22) Filed: Feb. 2, 2024

Related U.S. Application Data
(60) Provisional application No. 63/542,289, filed on Oct. 3, 2023.

(51) Int. Cl. H04J 3/06; H04L 69/28

(52) U.S. Cl. CPC H04J 3/0667; H04L 69/28

(57) ABSTRACT

A coordinator communication device in a communication network determines that a time period is to begin during which only the coordinator communication device will have opportunities to transmit. The time period includes a plurality of time cycles, each time cycle i) beginning with the coordinator communication device transmitting a beacon signal and ii) including a transmit opportunity that follows the beacon signal. The transmit opportunity is for the coordinator communication device. The coordinator communication device transmits one or more signals to follower communication devices in the communication network to prompt the follower communication devices to refrain from transmitting during the time period. During one or more transmit opportunities of the time period, the coordinator communication device transmits one or more time-sensitive packets.

### CROSS REFERENCES TO RELATED APPLICATIONS

This application claims the benefit of U.S. Provisional Patent App. No. 63/542,289, entitled “PTP Accuracy for Multi-Drop 10Base-T1s PLCA Network,” filed on Oct. 3, 2023, the disclosure of which is expressly incorporated herein by reference in its entirety.

### FIELD OF TECHNOLOGY

The present disclosure relates generally to communication networks, and more particularly to quieting transmissions in a communication network.

### BACKGROUND

Some communication networks use a shared communication medium, and such communication networks often use collision avoidance techniques for avoiding situations in which multiple communication devices transmit at the same time (a “collision”), which typically prevents one or more of the transmissions from being correctly received. For example, some communication networks use a token ring method in which a communication device can only transmit on the communication medium when the communication device is in possession of a token (typically a set of bits), where the token is passed from communication device to communication device in the network so that only one communication device has the token at any given time. As another example, some communication networks use a time-division multiple access (TDMA) technique in which communication devices are assigned respective time slots in which the communication devices are permitted to transmit on the communication medium, where each time slot is typically only assigned a single communication device.

The Institute for Electrical and Electronics Engineers (IEEE) Standard 802.3cg defines a physical layer (PHY)-level collision avoidance (PLCA) technique in which transmit opportunities for devices in a network are scheduled in repeating time cycles. Each time cycle begins with a coordinator transmitting a beacon transmission, which signals to follower devices that a new time cycle has begun. Each device in the network has a respective node identifier (ID) from a set of values 0, 1, 2, . . . , N−1, where N is the number of devices in the network. The node ID defines an ordering of transmit opportunities during the time cycle. For example, the device with node ID 0 (the coordinator) has a first-occurring transmit opportunity after the beacon transmission; the device with node ID 1 has a next-occurring transmit opportunity after the transmit opportunity of the device with node ID 0 ends; the device with node ID 2 has a next-occurring transmit opportunity after the transmit opportunity of the device with node ID 1 ends; etc. When the transmit opportunity of the device with node ID N−1 ends, the time cycle ends, and the coordinator transmits a next beacon transmission to signal that a new time cycle has begun.

### SUMMARY

In an embodiment, a method for time-sensitive communications in a communication network includes: determining, at a coordinator communication device, that a time period is to begin during which only the coordinator communication device will have opportunities to transmit, the time period comprising a plurality of time cycles, each time cycle i) beginning with the coordinator communication device transmitting a beacon signal and ii) including a transmit opportunity that follows the beacon signal, the transmit opportunity for the coordinator communication device; transmitting, by the coordinator communication device, one or more signals to follower communication devices to prompt the follower communication devices to refrain from transmitting during the time period; and transmitting, by the coordinator communication device, one or more time-sensitive packets during one or more transmit opportunities of the time period.

In another embodiment, the communication network operates according to a communication protocol that defines repeating first time cycles and specifies that each of multiple communication devices is provided a respective first transmit opportunity in each first time cycle; and the time period comprises a plurality of second time cycles, each second time cycle including a second transmit opportunity that follows the beacon signal.

In another embodiment, a network interface device for communicating in a communication network comprises: transmit circuitry; and controller circuitry that is configured to: determine that a time period is to begin during which only the coordinator communication device will have opportunities to transmit, the time period comprising a plurality of time cycles, each time cycle i) beginning with the coordinator communication device transmitting a beacon signal and ii) including a transmit opportunity that follows the beacon signal, the transmit opportunity for the coordinator communication device, control the transmit circuitry to transmit one or more signals to follower communication devices to prompt the follower communication devices to refrain from transmitting during the time period, and control the transmit circuitry to transmit one or more time-sensitive packets during one or more transmit opportunities of the time period.

In another embodiment, the communication network operates according to a communication protocol that defines repeating first time cycles and specifies that each of multiple communication devices is provided a respective first transmit opportunity in each first time cycle; and the time period comprises a plurality of second time cycles, each second time cycle including a second transmit opportunity that follows the beacon signal.

### BRIEF DESCRIPTION OF THE DRAWINGS

FIG. 1 is simplified diagram of an example in-vehicle communication network, according to an embodiment.

FIG. 2 is a timing diagram illustrating an example time schedule corresponding to a physical layer (PHY)-level collision avoidance (PLCA) of a communication protocol defined by the Institute for Electrical and Electronics Engineers (IEEE) Standard 802.3cg.

FIG. 3 is a timing diagram of an example time schedule in which a coordinator communication device quiets transmissions of one or more communication devices during a time period, according to an embodiment.

FIG. 4 is a timing diagram illustrating an example time period in which only a coordinator communication device has transmit opportunities and waits for two or more beacon signals to be transmitted before transmitting a packet, according to an embodiment.

FIG. 5 is a flow diagram of an example method for time-sensitive communications in a communication network, according to an embodiment.

FIG. 6 is a flow diagram of an example method for operating during a time period in which only a coordinator communication device has transmit opportunities, according to an embodiment.

FIG. 7 is a flow diagram of an example method for transmitting one or more time-sensitive packets during time period in which only a coordinator communication device has transmit opportunities, according to an embodiment.

FIG. 8 is a simplified block diagram of an example network interface that is configured to quiet transmissions in a communication network, according to an embodiment.

### DETAILED DESCRIPTION

In some embodiments described below, a coordinator device in a shared communication medium network transmits one or more signals to one or more follower devices on the network to quiet transmissions of the one or more follower devices during a time period. Quieting transmissions of the one or more follower devices during the time period is useful for performing certain operations during the time period. As an illustrative example, the coordinator device can use the time period to perform one or more operations, such as transmitting one or more time-sensitive packets, performing a measurement (e.g., a noise/interference level measurement, a noise/interference power measurement, an echo measurement, etc.), etc.

In some environments, such as powered vehicles and industrial settings, it is useful to synchronize clocks of devices on a network and/or to transmit a packet at a relatively precise time. However, with typical collision avoidance techniques used in shared communication medium networks, it is difficult to ensure that packets are transmitted at precise times, with minimal latency, and/or with predictable latency. For example, when a packet becomes available for transmission, there may be a variable delay until the device gains a transmit opportunity with the shared memory when using a collision avoidance procedure such as described above.

On the other hand, with techniques such as described herein, a coordinator device can transmit one or more signals to one or more follower devices on the network to quiet transmissions of the one or more follower devices during a time period so that the coordinator device can use the time period to transmit time-sensitive packets, according to some embodiments.

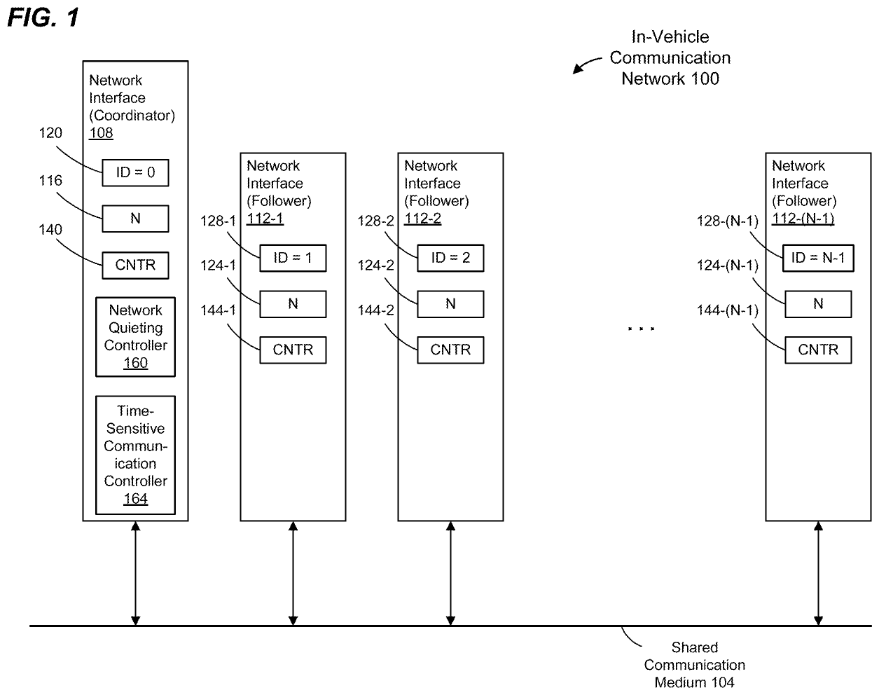

FIG. 1 is simplified diagram of an example in-vehicle communication network 100 in which various aspects, features, and elements described herein are implemented in accordance with various embodiments of this disclosure. The communication network 100 includes a shared communication medium 104, which comprises a twisted-pair cable, i.e., a pair of twisted metallic wires, in an embodiment. In other embodiments, the shared communication medium 104 comprises another suitable communication medium, such as a cable with multiple twisted pairs of metallic wires, a coaxial cable, over-the-air, etc.

Multiple network interfaces 108, 112 are communicatively coupled to the shared communication medium 104 and are configured to communicate via the shared communication medium 104. In an embodiment, the multiple network interfaces 108, 112 are configured to operate according to a communication protocol defined by the Institute for Electrical and Electronics Engineers (IEEE) Standard 802.3cg, and FIG. 1 is described with reference to the IEEE Standard 802.3cg merely for explanatory purposes. In other embodiments, the multiple network interfaces 108, 112 are configured to operate according to other suitable communication protocols.

The network interface 108 is included in an electronic control unit (ECU) of a vehicle, in an embodiment. The ECU also includes a processor and a memory coupled to the processor (not shown), in an embodiment. The memory stores machine readable instructions that, when executed by the processor, cause the processor to perform various acts.

Each of at least some of the network interfaces 112 corresponds to a vehicle component that includes one or more of: i) a sensor (e.g., a touchscreen, a pressure sensor, a camera, a RADAR sensor, a LIDAR sensor, a temperature sensor, etc.), ii) an actuator (e.g., an actuator to operate a door lock, a switch, etc.), iii) a controller, etc. In some embodiments, each of at least some of the network interfaces 112 is coupled to a processor and/or a memory coupled to the processor (not shown), in an embodiment. The memory stores machine readable instructions that, when executed by the processor, cause the processor to perform various acts.

The network interface 108 corresponds to a coordinator communication device (sometimes referred to herein as “the coordinator 108” for brevity), and the network interfaces 112 correspond to respective follower communication devices (sometimes referred to herein as “the followers 112” for brevity). The coordinator 108 includes a memory 116 (e.g., a register, one or more locations in a memory device such as a random access memory (RAM), a solid state memory, etc.) that stores a value of a parameter that indicates a number, N, of network interfaces 108, 112 in the communication network 100. The parameter that indicates the number of network interfaces 108, 112 in the communication network 100 is sometimes referred to herein as “N” for brevity. The coordinator 108 is configured to maintain N. For example, the coordinator 108 determines N and stores N in the memory 116.

According to the IEEE Standard 802.3cg, each of the network interfaces 108, 112 has a respective node identifier (ID) selected from a set of values {0, 1, 2, . . . , N−1}. More specifically, the network interface 108 (coordinator) has the node ID 0, and the network interfaces 112 (followers) have respective node IDs selected from a set of values {1, 2, . . . , N−1}.

The coordinator 108 includes a memory 120 (e.g., a register, one or more locations in a memory device such as a RAM, a solid state memory, etc.) that stores the device ID of the coordinator 108. In an embodiment, the memory 116 and the memory 120 correspond to different memory devices (e.g., different registers, different RAMs, different solid state memories, etc.). In another embodiment, the memory 116 and the memory 120 correspond to different sets of one or more memory locations in a single memory device.

Each follower 112 includes a memory 124 (e.g., a register, one or more locations in a memory device such as a RAM, a solid state memory, etc.) that stores a value that indicates there are N devices in the communication network 100. Each follower 112 is configured to maintain N. For example, each follower 112 determines N and stores the value that indicates N in the memory 124.

Each follower 112 also includes a memory 128 (e.g., a register, one or more locations in a memory device such as a RAM, a solid state memory, etc.) that stores the device ID of the follower 112. In some embodiments, the memory 124 and the memory 128 correspond to different memory devices (e.g., different registers, different RAMs, different solid state memories, etc.). In other embodiments, the memory 124 and the memory 128 correspond to different sets of one or more memory locations in a single memory device.

As discussed above, the IEEE Standard 802.3cg defines a physical layer (PHY)-level collision avoidance (PLCA) technique in which transmit opportunities for the network interfaces 108, 112 in the communication network 100 are scheduled in repeating time cycles. Each time cycle begins with the coordinator 108 transmitting a beacon transmission, which signals to the followers 112 that a new time cycle has begun. The node IDs of the network interfaces 108, 112 defines an ordering of transmit opportunities during the time cycle. For example, the coordinator 108 (with node ID 0) has a first-occurring transmit opportunity after the beacon transmission; the follower 112-1 (with node ID 1) has a next-occurring transmit opportunity after the transmit opportunity of the coordinator 108 ends; the follower 112-2 (with node ID 2) has a next-occurring transmit opportunity after the transmit opportunity of the follower 112-1 ends; etc. When the transmit opportunity of the follower 112-(N−1) (with node ID N−1) ends, the time cycle ends, and the coordinator 108 transmits a next beacon transmission to signal that a new time cycle has begun.

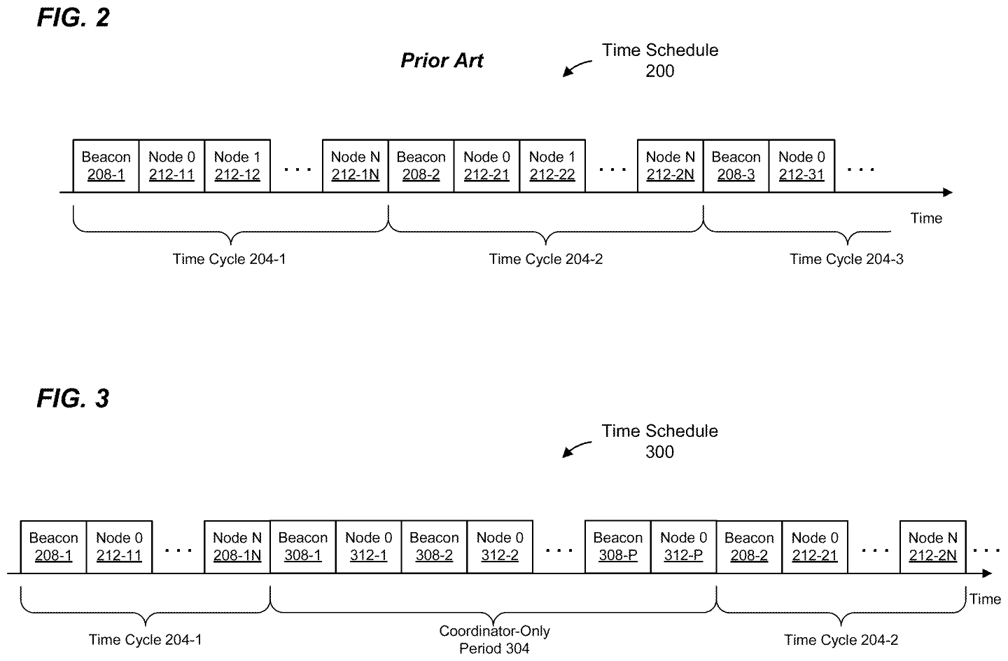

FIG. 2 is a timing diagram illustrating a time schedule 200 corresponding to the PLCA technique of the IEEE Standard 802.3cg. The time schedule 200 includes a plurality of repeating time cycles 204. Each time cycle 204 begins with the coordinator 108 transmitting a beacon signal 208 that signals to the followers 112 that a new time cycle 204 has begun. Additionally, during each time cycle 204, each of the network interfaces 108, 112 is provided a respective transmit opportunity 212 in the time cycle 204. For example, the coordinator 108 is provided the transmit opportunity 212-1 after the beacon signal 208 ends; the follower 112-1 is provided the transmit opportunity 212-2; the follower 112-2 is provided the transmit opportunity 212-3; etc. When the transmit opportunity 212-N ends, the time cycle 204 ends, and the coordinator 108 transmits a next beacon signal 208 to signal to the followers 112 that a new time cycle 204 has begun.

During a transmit opportunity 212, a network interface 108, 112 with the node ID that corresponds to the transmit opportunity 212 is permitted to begin transmitting. Each transmit opportunity 212 has a minimum duration Tmin. Thus, if the network interface 108, 112 with the node ID that corresponds to the transmit opportunity 212 does not transmit during the transmit opportunity 212, the transmit opportunity 212 has a duration of Tmin. Otherwise, if the network interface 108, 112 with the node ID that corresponds to the transmit opportunity 212 begins transmitting during the transmit opportunity 212, the transmit opportunity 212 ends when the network interface 108, 112 ends the transmission, assuming a duration of the transmission is greater than Tmin. Thus, each network interface 108, 112 is configured to determine when the transmit opportunity 212 ends based on measuring a time duration from when the transmit opportunity 212 began, and determining when the time duration equals Tmin, according to an embodiment. Additionally, in a scenario in which a transmission begins during a transmit opportunity 212, each network interface 108, 112 is configured to determine when the transmit opportunity 212 ends based on determining when the transmission has ended, according to an embodiment.

Each network interface 108, 112 includes a counter that maintains a count that indicates a current transmit opportunity 212 during the time cycle 204, in an embodiment. Referring now to FIGS. 1 and 2, the coordinator 108 includes a counter 140, and the followers 112 include respective counters 144, in an embodiment. The counters 140, 144 are used by the network interfaces 108, 112 to keep track of a current transmit opportunity 212, in an embodiment. For example, each network interface 108, 112 increments the counter 140, 144 in response to determining that a transmit opportunity has ended. In an embodiment, when the counter 140 indicates that the current transmit opportunity is the transmit opportunity 212-N, and in connection with (e.g., in response to) the transmit opportunity 212-N ending, the coordinator 108 resets the counter 140 to zero. Additionally, when the counter 140 indicates that the current transmit opportunity is the transmit opportunity 212-N, and in connection with (e.g., in response to) the transmit opportunity 212-N ending, the coordinator 108 transmits the beacon 208 to signal to the followers 112 that a new time cycle 204 is beginning.

Similarly, when the counter 144 indicates that the current transmit opportunity is the transmit opportunity 212-N, and in response to the transmit opportunity 212-N ending, the follower 112 resets the counter 144 to zero, according to an embodiment. Additionally, the follower 112 is configured to reset the counter 144 to zero in response to receiving a beacon 208 from the coordinator 108, in some embodiments. If a counter 144 of a follower 112 becomes offset from the time schedule 200 for some reason (e.g., the counter 144 indicates a count of 5 when the actual transmit opportunity 212 corresponds to a counter value of 6), resetting the counter 144 to zero in response to receiving a beacon 208 is useful for facilitating the follower 112 to resynchronize the counter 144 for a next time cycle 204.

With the time schedule 200, each transmit opportunity 212 has a variable duration. Therefore, it may be difficult for a network interface 108, 112 to ensure that a time-sensitive packet is transmitted at a precise time, with a minimum latency, and/or with predictable latency. For example, when a packet becomes available for transmission, there may be a variable delay until the network interface 108, 112 gains a transmit opportunity 212, and thus a time delay until the packet is transmitted may be too large and/or unpredictable for an application that requires packets to be transmitted with a minimum latency and/or at precise times.

In some embodiments described below, the coordinator 108 transmits one or more signals to one or more followers 112 on the communication medium 104 to quiet transmissions of the one or more followers 112 during a time period. The coordinator device 108 can then use the time period to perform one or more operations, such as transmitting a time-sensitive packet, performing a measurement (e.g., noise/interference level, noise/interference power, etc.), etc.

FIG. 3 is a timing diagram illustrating an example time schedule 300 in which the coordinator 108 quiets transmissions of the one or more followers 112 during a time period, according to an embodiment. The time schedule 300 is implemented in a communication network such as the example communication network 100 of FIG. 1, according to some embodiments, and the time schedule 300 is described with reference to FIG. 1 for ease of explanation. In other embodiments, the time schedule 300 is implemented in another suitable communication network different than the communication network 100. Similarly, the communication network 100 implements another suitable time schedule different than the time schedule 300, in some embodiments.

The time schedule 300 include a plurality of time cycles 204 described above with reference to FIG. 2. Additionally, the time schedule 300 includes a time period 304 between two time cycles 204. During the time period 304, the follower devices 112 refrain from transmitting, as will be described below. The time period 304 is sometimes referred to herein as the “coordinator-only period 304” because only the coordinator 108 transmits during the time period 304, in some embodiments.

The coordinator 108 includes a network quieting controller 160 (FIG. 1) that is configured to determine when the communication network 100 is to enter the coordinator-only period 304. Determining when the communication network 100 is to enter the coordinator-only period 304 includes determining that a time-sensitive packet is ready to be transmitted, according to an embodiment. A time-sensitive packet corresponds to one or more of: i) a packet that is to be transmitted at a determined time with a particular precision, ii) a packet that is to be transmitted with a maximum latency between a) a first time at which a controller of a communication device initiates transmission of the packet and b) a second time at which transmission of the packet begins on the shared communication medium 104, and iii) a packet that is to be transmitted with a determined latency between a) the first time at which the controller initiates transmission of the packet and b) the second time at which transmission of the packet begins on the shared communication medium 104 (e.g., with a particular precision regarding the determined latency, the determined latency being between a maximum latency and a minimum latency, etc.), according to various embodiments.

Determining when the communication network 100 is to enter the coordinator-only period 304 includes determining that a time-sensitive packet is to be transmitted at a particular time in the future, according to another embodiment. Determining when the communication network 100 is to enter the coordinator-only period 304 includes determining that a signal quality measurement is to be performed, where the signal quality measurement requires that the followers 112 refrain from transmitting, according to another embodiment. The signal quality measurement includes a noise level and/or power measurement, an interference level and/or power measurement, etc., according to various embodiments.

When the network quieting controller 160 is included in a physical layer (PHY) processor of the network interface 108, determining when the communication network 100 is to enter the coordinator-only period 304 includes receiving a signal from a processor corresponding to a level in a communication protocol stack different than the PHY layer (e.g., a media access control (MAC) layer or a layer above the MAC layer), from a precision time protocol (PTP) controller, from a signal quality measurement controller, from an echo measurement controller, etc., according to various embodiments. When the network quieting controller 160 is included in a MAC layer processor of the network interface 108, determining when the communication network 100 is to enter the coordinator-only period 304 includes receiving a signal from a processor corresponding to a level in a communication protocol stack different than the MAC layer (e.g., a layer above the MAC layer), from the PTP controller, from the signal quality measurement controller, from the echo measurement controller, etc., according to various embodiments.

In other embodiments, the network quieting controller 160 institutes coordinator-only time periods 304 additionally or alternatively according to a schedule and/or a time interval, and determining when the communication network 100 is to enter the coordinator-only period 304 is based on the schedule and/or time interval, according to an embodiment. As an illustrative example, the network quieting controller 160 institutes coordinator-only time periods 304 at an interval of one second (or another suitable time interval), according to an embodiment. In some such embodiments, the coordinator-only time periods 304 thus occur at predictable times and the coordinator 108 knows when time-sensitive packets can be transmitted, i.e., knows when at least some coordinator-only time periods 304 will occur.

In an embodiment, the network quieting controller 160, in response to determining that the communication network 100 is to enter the coordinator-only period 304, transmits one or more signals to the followers 112 to prompt the followers 112 to refrain from transmitting during the coordinator-only period 304, as will be described further below. The one or more signals that prompt the followers 112 to refrain from transmitting during the coordinator-only period 304 are sometimes referred to herein as “the one or more quieting signals.” The followers 112 refrain from transmitting during the coordinator-only period 304 in response to receiving the one or more quieting signals transmitted by the coordinator 108.

Similar to each time cycle 204, the coordinator 108 transmits a beacon signal 308-1 at a beginning of the coordinator-only period 304. Transmitting the beacon signal 308-1 prompts the followers 112 to reset the counters 144 to zero if they have not done so already (e.g., because the transmit opportunity 28-1N ended), in some embodiments. Like each of the time cycles 204, a transmit opportunity 312-1 for the coordinator 108 follows the transmission of the beacon signal 308-1. Unlike the time cycles 204, however, the coordinator 108 transmits another beacon signal 308-2 in connection with an end of the transmit opportunity 312-1. Transmitting the beacon signal 308-2 prompts the followers 112 to reset the counters 144 to zero, in some embodiments. Like each of the time cycles 204, a transmit opportunity 312-2 for the coordinator 108 follows the transmission of the beacon signal 308-2. The transmission of another beacon signal 308 in connection with an end of a transmit opportunity 312 repeats until an end of the coordinator-only period 304.

Transmission of the beacon signal(s) 308-2 to 308-P (where P is a suitable integer greater than one) prompts the followers 112 to keep resetting the counters 144 to zero as discussed above, which prevents the followers 112 from obtaining transmit opportunities during the coordinator-only period 304, according to an embodiment. Thus, only the coordinator 108 obtains transmit opportunities 312 during the coordinator-only period 304, according to an embodiment. The beacon signal(s) 308-2 to 308-P is/are example(s) of quieting signal(s).

In some embodiments, the coordinator 108 optionally transmits (e.g., during the transmit opportunity 212-11 of the time cycle 204-1, or during an earlier time cycle 204) a first packet that notifies the followers 112 that the coordinator-only period 304 will start at an end of the time cycle 204-1. In response to the first packet that notifies the followers 112 that the coordinator-only period 304 will start at the end of the time cycle 204-1, the followers 112 refrain from transmitting during the coordinator-only period 304. Thus, the first packet is another example of a quieting signal.

In an embodiment, the first packet is configured to prompt the followers 112 to set the memory 124 to a value that indicates there is only one node in the communication network 100 during the coordinator-only period 304. Setting the memory 124 to indicate that there is only one node in the communication network 100 during the coordinator-only period 304 causes the followers 112 to refrain from transmitting during the coordinator-only period 304, according to an embodiment.

In some embodiments, the coordinator 108 optionally transmits (e.g., during the transmit opportunity 308-P of the coordinator-only period 304, or during an earlier time cycle 308 of the coordinator-only period 304) a second packet that notifies the followers 112 that the coordinator-only period 304 will end after the transmit opportunity 312-P. In an embodiment, the second packet is configured to prompt the followers 112 to set the memory 124 value to back to a value that indicates there are N nodes in the communication network 100.

During one or more of the transmit opportunities 312, the coordinator 108 transmits one or more time-sensitive packets, according to an embodiment. Referring again to FIG. 1, the coordinator 108 includes a time-sensitive communication controller 164 that is configured to generate time-sensitive messages and/or packets for transmission via the communication medium 104.

In some embodiments, the time-sensitive communication controller 164 provides a control signal to the network quieting controller 160, where the control signal indicates that the time-sensitive communication controller 164 has a time-sensitive message that is to be transmitted via the communication medium 104; the network quieting controller 160 determines when a coordinator-only period 304 will begin based on the control signal from the time-sensitive communication controller 164.

In another embodiment, the time-sensitive communication controller 164 provides a time-sensitive message that is to be transmitted via the communication medium 104 to a MAC layer processor (not shown) of the coordinator 108, and the MAC layer processor generates a time-sensitive packet that includes the time-sensitive message. Additionally, the MAC layer processor informs the network quieting controller 160 that the MAC layer processor has a time-sensitive packet that is to be transmitted via the communication medium 104; the network quieting controller 160 determines when a coordinator-only period 304 will begin based on the time-sensitive packet generated by the MAC processor.

In an embodiment, the time-sensitive communication controller 164 includes, is included in, or is coupled to a PTP controller. PTP is a protocol for synchronizing clocks of devices on a network to sub-microsecond precision. In PTP, a timeTransmitter device on a network maintains a primary clock, and one or more timeReceiver devices on the network maintain respective client clocks that are synchronized with the primary clock. To facilitate synchronizing the client clocks with the primary clock, the timeTransmitter device transmits a packet with a timestamp to the timeReceiver devices, the timestamp being based on the primary clock. The timeReceiver devices use the timestamp to adjust the client clocks to be synchronized with the primary clock. In embodiments that include a PTP controller, the PTP controller generates PTP messages, such as PTP sync messages and other PTP messages. At least some of the PTP messages are time-sensitive (e.g., messages with timestamps and/or messages that are to be included in timestamped packets) and are transmitted by the coordinator 108 during the coordinator-only period in time-sensitive packets, at least in some embodiments. As an illustrative example in the context of PTP, the coordinator device can quiet transmissions of one or more follower devices during a time period so that the coordinator device can use the time period to transmit certain time-sensitive PTP packets, such as time-stamped packets, according to some embodiments.

During one or more of the transmit opportunities 312, the coordinator 108 additionally or alternatively makes one or more signal quality measurements, according to an embodiment. For example, in some embodiments, the time-sensitive communication controller 164 includes, is included in, or is coupled to a signal quality measurement controller that is configured to perform one or more signal quality measurements during the one or more of the transmit opportunities 312. The signal quality measurement controller includes a hardware state machine that performs acts corresponding to performing signal quality measurements, according to an embodiment. Additionally or alternatively, the signal quality measurement controller includes a processor coupled to a memory that stores machine readable instructions, and the machine readable instructions, when executed by the processor, cause the processor to perform acts corresponding to performing signal quality measurements, in another embodiment.

During one or more of the transmit opportunities 312, the coordinator 108 additionally or alternatively makes one or more echo measurements, according to an embodiment. For example, in some embodiments, the time-sensitive communication controller 164 includes, is included in, or is coupled to an echo measurement controller that is configured to perform one or more signal echo measurements during the one or more of the transmit opportunities 312. The echo measurement controller includes a hardware state machine that performs acts corresponding to performing echo measurements, according to an embodiment. Additionally or alternatively, the signal quality measurement controller includes a processor coupled to a memory that stores machine readable instructions, and the machine readable instructions, when executed by the processor, cause the processor to perform acts corresponding to performing echo measurements, in another embodiment.

The time-sensitive communication controller 164 includes a hardware state machine that performs acts corresponding to time-sensitive communications such as described herein, in an embodiment. Additionally or alternatively, the time-sensitive communication controller 164 includes a processor coupled to a memory that stores machine readable instructions, and the machine readable instructions, when executed by the processor, cause the processor to perform acts corresponding to time-sensitive communications such as described herein, in another embodiment.

When the coordinator period 304 begins, there may be one or more other packets already enqueued at the coordinator 308 for transmission ahead of a time-sensitive packet. At least in some such scenarios, if the one or more other packets are transmitted during the transmit opportunity 312-1 prior to transmitting the time-sensitive packet, a value of a time stamp in the time-sensitive packet may differ significantly from a time at which the time-sensitive packet appears on the communication medium 104 as compared to if the time-sensitive packet was transmitted first during the transmit opportunity 312 and ahead of the one or more other packets.

In some embodiments, the coordinator 308 waits for two or more beacon signals 308 to be transmitted before transmitting a time-sensitive packet during the coordinator-only period 304, i.e., the coordinator 308 waits for until at least the transmit opportunity 312-2 to transmit the time-sensitive packet. Waiting to transmit the time-sensitive packet in such a manner helps to ensure that the time-sensitive packet is transmitted first during a later transmit opportunity 312 (i.e., the transmit opportunity 312-2 or later), for example by ensuring that any packets enqueued ahead of the time-sensitive packet are transmitted during one or more prior transmit opportunities 312.

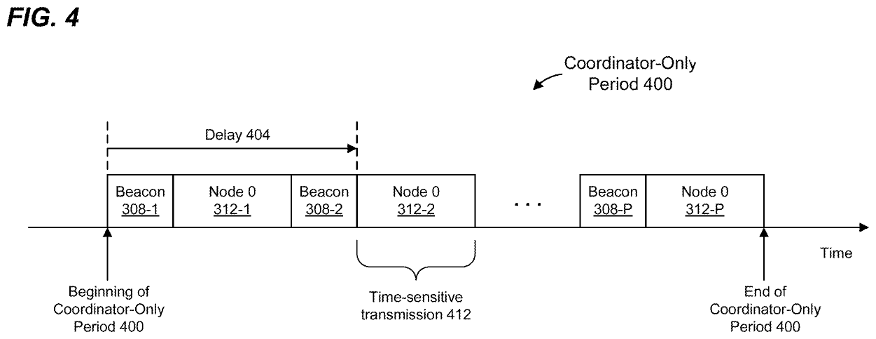

FIG. 4 is a timing diagram illustrating an example coordinator-only period 400 in which the coordinator 108 waits for two or more beacon signals 308 to be transmitted before transmitting a time-sensitive packet, according to an embodiment. The coordinator-only period 400 is implemented in a communication network such as the example communication network 100 of FIG. 1, according to some embodiments, and the coordinator-only period 400 is described with reference to FIG. 1 for ease of explanation. In other embodiments, the coordinator-only period 400 is implemented in another suitable communication network different than the communication network 100. Similarly, the communication network 100 implements another suitable coordinator-only period different than the coordinator-only period 400, in some embodiments.

The coordinator-only period 400 is similar to the coordinator-only period 304 of FIG. 3 and like-numbered elements are not described in detail for brevity. The coordinator-only period 400 is used in a time schedule the same as or similar to the time schedule 300, in some embodiments. In other embodiments, the coordinator-only period 400 is used in a suitable time schedule different than the time schedule 300.

The coordinator 108 determines (e.g., the time-sensitive communication controller 164 and/or the network quieting controller 160 determines) a delay 404 until a time-sensitive transmission 412 is to begin. Determining the delay 404 includes determining a number of beacon signals 308 corresponding to the delay 404, according to an embodiment. Determining the delay 404 additionally or alternatively includes determining a time value corresponding to the delay 404, according to another embodiment.

The determined delay 404 indicates a transmit opportunity 312 in which to begin the time-sensitive transmission 412, according to an embodiment. Although FIG. 4 illustrates the delay 404 as corresponding to the transmission of two beacons signals 308, in other embodiments and/or scenarios, the delay 404 corresponds to transmission of more than two beacon signals 308.

After the delay 404, the coordinator 108 begins the time-sensitive transmission 412 (e.g., transmission of a time-sensitive packet). In an embodiment, the time-sensitive transmission 412 is a first-occurring transmission in the transmit opportunity 312. Transmitting the time-sensitive packet 412 prior to transmitting any other packets in the transmit opportunity 312 helps ensure that a value of a time stamp in the time-sensitive packet is more accurate (with respect to a time at which the time-sensitive packet appears on the communication medium 104) as compared to if the time-sensitive packet was transmitted during the transmit opportunity 312 after the transmission of one or more other packets, in some embodiments.

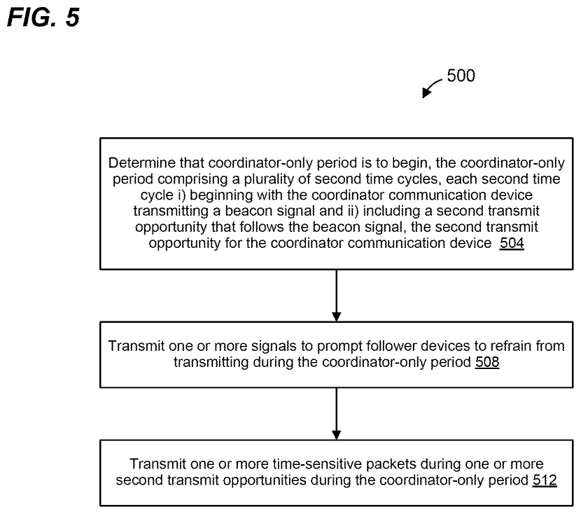

FIG. 5 is a flow diagram of an example method 500 for time-sensitive communications in a communication network, according to an embodiment. In an embodiment, the method 500 is performed in a communication network that operates according to a communication protocol which defines repeating first time cycles, wherein the communication protocol specifies that each of multiple communication devices is provided a respective first transmit opportunity in each first time cycle. For example, the communication protocol uses a PLCA technique such as described herein with reference to FIG. 2, according to an embodiment. In other embodiments, the method 500 is performed in a communication network that operates according to another suitable communication protocol.

The method 500 is implemented in a communication network like the communication network 100 of FIG. 1, in an embodiment, and the method 500 is described with reference to FIG. 1 for ease of explanation. In other embodiments, the method 500 is implemented in another suitable communication network different than the communication network 100. The method 500 is implemented by the coordinator 108 of FIG. 1, in an embodiment. In other embodiments, the method 500 is implemented by another suitable communication device different than the coordinator 108.

The method 500 is implemented using a time schedule like the example time schedule 300 of FIG. 3, in an embodiment, and the method 500 is described with reference to the time schedule 300 for ease of explanation. The method 500 is implemented using a coordinator-only period like the example coordinator-only period 400 of FIG. 4, in an embodiment, and the method 500 is described with reference to the coordinator-only period 400 for ease of explanation. In other embodiments, the method 500 is implemented using a suitable time schedule different than the time schedule 300 and/or using a suitable coordinator-period different than the coordinator-only period 400.

At block 504, a coordinator communication device determines (e.g., the coordinator 108 determines, the network quieting controller 160 determines, etc.) that a time period is to begin during which only the coordinator 108 will have opportunities to transmit. The time period comprises a plurality of second time cycles, each second time cycle i) beginning with the coordinator communication device transmitting a beacon signal and ii) including a second transmit opportunity that follows the beacon signal, the second transmit opportunity for the coordinator communication device. For example, the time period is the time period 304 of FIG. 3, in an embodiment. The time period is the time period 400 of FIG. 4, in another embodiment. The time period is another suitable time period different than the time period 304 of FIG. 3 and the time period 400 of FIG. 4, in other embodiments.

At block 508, the coordinator transmits (e.g., the coordinator 108 transmits) one or more signals to follower communication devices (e.g., the followers 112) to prompt the follower communication devices to refrain from transmitting during the time period. In an embodiment, the one or more signals transmitted at block 508 comprise beacon signals (e.g., the beacon signals 308). In an embodiment, the communication protocol specifies that i) the coordinator communication device is to transmit a beacon signal to signal a respective start of each first time cycle, and ii) the coordinator communication device has a respective initial first transmit opportunity in each first time cycle that immediately follows the beacon signal; and transmitting the one or more signals at block 508 comprises, for each of multiple second transmit opportunities during the time period, the coordinator communication device transmitting a subsequent beacon signal immediately following the second transmit opportunity.

In another embodiment, the communication protocol specifies that, for each first time cycle, i) each communication device in the communication network is given a respective first transmit opportunity during the first time cycle, and ii) after all communication devices in the communication network have had transmit opportunities in the first time cycle, the coordinator communication device is to transmit a next beacon signal to signal a start of a next first time cycle; the follower communication devices maintain respective parameters that indicate a number of communication devices in the communication network; and transmitting the one or more signals at block 508 comprises: in connection with the time period, transmitting a packet that prompts the follower communication devices to set the respective parameters of the follower communication devices to indicate that there is only one communication device in the communication network.

At block 512, the coordinator communication device transmits (e.g., the coordinator 108 transmits) one or more time-sensitive packets during one or more second transmit opportunities of the time period. Transmitting the one or more time-sensitive packets at block 512 comprises transmitting a packet that includes a timestamp that indicates a time of a clock of the coordinator communication device at which the packet was transmitted by the coordinator communication device, according to an embodiment. For example, transmitting the packet that includes the timestamp facilitates the follower communication devices synchronizing respective clocks of the follower communication devices to the clock of the coordinator communication device, in an embodiment. Transmitting the packet that includes the timestamp comprises transmitting a sync message defined by the PTP to facilitate the follower communication devices synchronizing the respective clocks of the follower communication devices to the clock of the coordinator communication device.

In another embodiment, the method 500 further comprises: the coordinator communication device maintaining (e.g., the coordinator 108 maintaining) a parameter that indicates a number of communication devices in the communication network; and in connection with the time period, the coordinator communication device setting (e.g., the coordinator 108 maintaining) the parameter to indicate that there is only one communication device in the communication network.

In another embodiment, the method 500 further comprises: the coordinator communication device waiting (e.g., the coordinator 108 waiting) for the coordinator communication device to transmit at least two beacon signals during the time period; and the coordinator communication device beginning transmission (e.g., the coordinator 108 beginning transmission) of the one or more time-sensitive packets during the time period only after waiting for the coordinator communication device to transmit the at least two beacon signals during the time period.

In another embodiment, the method 500 further comprises: the coordinator communication device determining (e.g., the coordinator 108 determining) a number of beacon signals to transmit during the time period before beginning transmission of the one or more time-sensitive packets during the time period, wherein the number of beacon signals is at least two; and the coordinator communication device beginning transmission (e.g., the coordinator 108 beginning transmission) of the one or more time-sensitive packets during the time period only after transmitting the number of beacon signals during the time period.

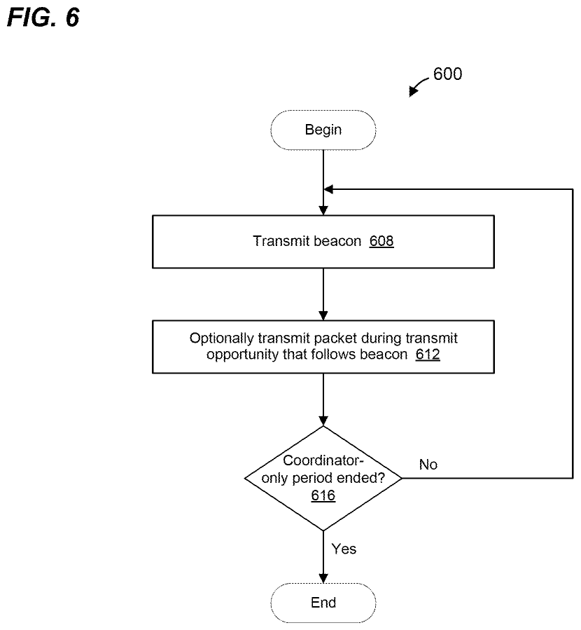

FIG. 6 is a flow diagram of an example method 600 for operating during a coordinator-only period, such as the coordinator-only period 304 (FIG. 3) and/or the coordinator-only period 400 (FIG. 4), according to an embodiment. The method 600 is performed in conjunction with the method 500 of FIG. 5, in an embodiment. In another embodiment, the method 600 is performed in conjunction with another suitable method for quieting a communication network different than the method 500.

The method 600 is implemented in a communication network like the communication network 100 of FIG. 1, in an embodiment, and the method 600 is described with reference to FIG. 1 for ease of explanation. In other embodiments, the method 600 is implemented in another suitable communication network different than the communication network 100. The method 600 is implemented by the coordinator 108 of FIG. 1, in an embodiment. In other embodiments, the method 600 is implemented by another suitable communication device different than the coordinator 108.

The method 600 is implemented in the context of a time schedule like the example time schedule 300 of FIG. 3, in an embodiment, and the method 600 is described with reference to the time schedule 300 for ease of explanation. The method 600 is implemented in the context of the example coordinator-only period 400 of FIG. 4, in an embodiment, and the method 600 is described with reference to the coordinator-only period 400 for ease of explanation. In other embodiments, the method 600 is implemented in the context of a suitable time schedule different than the time schedule 300 and/or a suitable coordinator-period different than the coordinator-only period 400.

The method 600 begins when the coordinator communication device begins a coordinator-only period. At block 608, the coordinator communication device transmits (e.g., the coordinator 108 transmits) a beacon signal. For example, the coordinator 108 transmits a beacon 308 during the coordinator-only period 304 and/or during the coordinator-only period 400.

At block 612, the coordinator communication device transmits (e.g., the coordinator 108 transmits) a packet during a transmit opportunity that follows the beacon transmitted at block 608. For example, the coordinator 108 transmits a packet during a transmit opportunity 312 that follows the beacon signal 308. Optionally, the coordinator communication device does not transmit anything during the transmit opportunity that follows the beacon transmitted at block 608. In such a scenario, the transmit opportunity ends after Tmin from when transmission of the beacon signal ends, in an embodiment. Otherwise, when a packet is transmitted, the transmit opportunity ends when transmission of the packet ends.

At block 616, the coordinator communication device determines (e.g., the coordinator 108 determines, the network quieting controller 160 determines, etc.) whether the coordinator-only period has ended. In response to determining that the coordinator-only period has ended, the flow ends. On the other hand, in response to determining that the coordinator-only period has not ended, the flow returns to block 608, at which the coordinator communication device transmits a next beacon signal. Transmission of the next beacon signal begins immediately after (or even before) an end of the transmit opportunity to help prevent a follower 112, e.g., the follower 112-1, from attempting to transmit during the transmit opportunity. If the coordinator 108 transmits a packet at block 612, transmission of the next beacon signal begins immediately after transmission of the packet ends, e.g., any time gap before an end of transmission of the packet and a beginning of transmission of the beacon is small enough that a follower 112, e.g., the follower 112-1, will not detect that the communication medium 104 is idle. Similarly, if the coordinator 108 does not transmit a packet at block 612, transmission of the next beacon signal begins before, at, or immediately after the transmit opportunity ends (at Tmin), e.g., any time gap before an end of the transmit opportunity and a beginning of transmission of the beacon is small enough that a follower 112, e.g., the follower 112-1, will not detect that the communication medium 104 is idle.

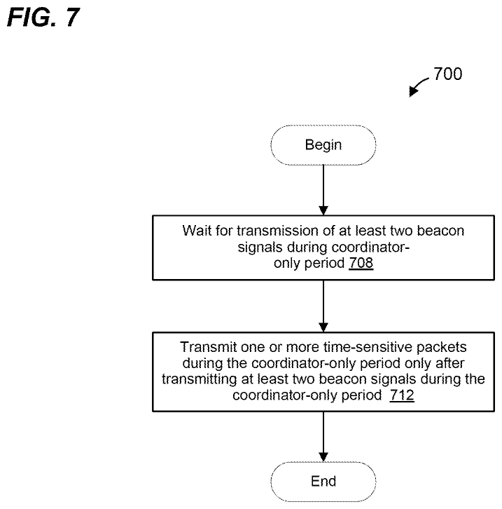

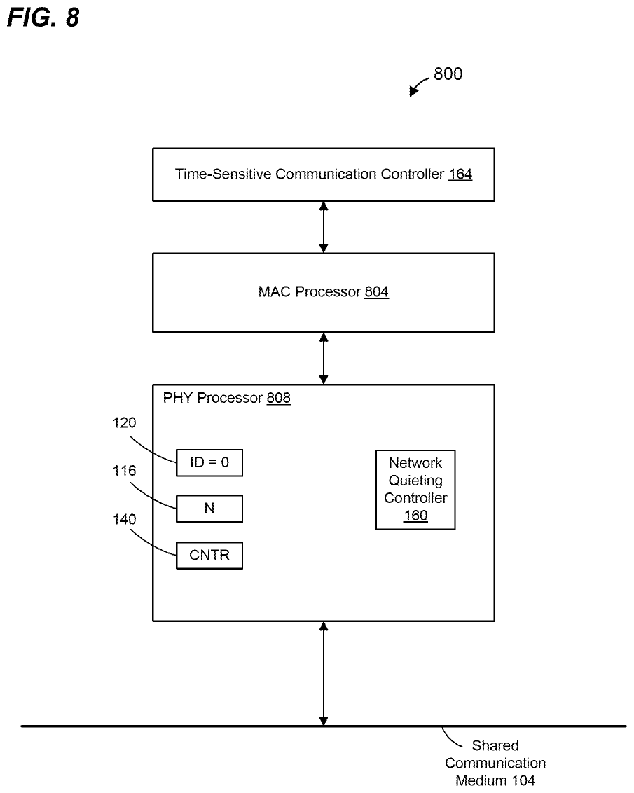

FIG. 7 is a flow diagram of an example method 700 for transmitting one or more time-sensitive packets during a coordinator-only period, such as the coordinator-only period 304 (FIG. 3) and/or the coordinator-only period 400 (FIG. 4), according to an embodiment. The method 700 is performed in conjunction with the method 500 of FIG. 5, in an embodiment. In another embodiment, the method 700 is performed in conjunction with another suitable method for quieting a communication network different than the method 500. The method 700 is performed in conjunction with the method 600 of FIG. 6, in an embodiment. In another embodiment, the method 700 is performed in conjunction with another suitable method for operating during a coordinator-only period different than the method 600.

The method 700 is implemented in a communication network like the communication network 100 of FIG. 1, in an embodiment, and the method 700 is described with reference to FIG. 1 for ease of explanation. In other embodiments, the method 700 is implemented in another suitable communication network different than the communication network 100. The method 700 is implemented by the coordinator 108 of FIG. 1, in an embodiment. In other embodiments, the method 700 is implemented by another suitable communication device different than the coordinator 108.

The method 700 is implemented in the context of a time schedule like the example time schedule 300 of FIG. 3, in an embodiment, and the method 700 is described with reference to the time schedule 300 for ease of explanation. The method 700 is implemented in the context of the example coordinator-only period 400 of FIG. 4, in an embodiment, and the method 700 is described with reference to the coordinator-only period 400 for ease of explanation. In other embodiments, the method 700 is implemented in the context of a suitable time schedule different than the time schedule 300 and/or a suitable coordinator-period different than the coordinator-only period 400.

The method 700 begins when the coordinator communication device begins a coordinator-only period. At block 708, the coordinator communication device waits (e.g., the coordinator 108 waits) for transmission of at least two beacon signals during the coordinator period. For example, the coordinator 108 waits for transmissions of at least two beacons 308 during the coordinator-only period 304 and/or during the coordinator-only period 400.

In an embodiment, the method 700 further comprises the coordinator communication device determining (e.g., the coordinator 108 determining) a delay period (e.g., the delay period 404) between a beginning of the coordinator-only period and a start of transmission of a time-sensitive packet. In another embodiment, the delay period is determined as a number of beacon signals to be transmitted prior to beginning transmission of a time-sensitive packet. In another embodiment, the delay period is determined in units of time.

At block 712, the coordinator communication device transmits (e.g., the coordinator 108 transmits) one or more time-sensitive packets during the coordinator period only after transmitting the at least two beacon signals. For example, the coordinator 108 transmits a time-sensitive packet 412 only after transmitting at least two beacons 308 during the coordinator-only 400.

Referring again to FIGS. 3 and 4, in some embodiments, the coordinator 108 grants to a follower 112 access to one or more of the transmit opportunities 312 so that the follower 112 can transmit during the one or more of the transmit opportunities 312, according to an embodiment. For example, the coordinator 108 transmits, during an earlier transmit opportunity, a packet to the follower 112 that informs the follower 112 that the follower 112 can transmit in a later transmit opportunity, in an embodiment. In response to receiving the packet, the follower 112 transmits a packet (or some other signal, such as a testing signal) during the transmit opportunity 312, in an embodiment.

FIG. 8 is a simplified block diagram of an example network interface 800 that is configured to quiet transmissions in a communication network, according to an embodiment. The network interface 800 corresponds to the network interface 108 of FIG. 1, in an embodiment. In another embodiment, the network interface 800 operates in a suitable communication network different than the communication network 100 of FIG. 1. Additionally, the network interface 108 of FIG. 1 has a suitable structure different than the network interface 800, in some embodiments.

In some embodiments, the network interface 800 is configured to operate according to a time schedule like the time schedule 300 of FIG. 3 or another suitable time schedule. In some embodiments, the network interface 800 is configured to operate according to a coordinator-only period like the coordinator-only period 304 of FIG. 3, the coordinator-only period 400 of FIG. 4, or another suitable coordinator-only period. In various embodiments, the network interface 800 is configured to perform one or more of the methods of FIGS. 5-7. In other embodiments, the network interface 800 performs other suitable methods different than the methods of FIGS. 5-7. In other embodiments, one or more of the methods of FIGS. 5-7 are implemented by a network interface that has a suitable structure different than the network interface 800.

The network interface 800 includes a MAC processor 804 coupled to a PHY processor 808. The MAC processor 804 is configured to perform MAC layer protocol operations with respect to packets that are received via the communication medium 104 and that are to be transmitted via the communication medium 104, in an embodiment. The MAC processor 804 operates according to a communication protocol such as described herein, or another suitable communication protocol. In an embodiment, the MAC processor 804 operates according to the IEEE Standard 802.3cg protocol.

The MAC processor 804 provides packet data to the PHY processor 808 for transmission via the communication medium 104. Additionally, the MAC processor 804 receives packet data from the PHY processor 808, the packet data corresponding to a signal received by the PHY processor 808 via the communication medium 104.

The PHY processor 808 is configured to receive packet data from the MAC processor 804, generate a transmit signal corresponding to the packet data, and transmit the signal via the communication medium 104. Similarly, the PHY processor 808 is configured to receive a signal from a respective communication medium 104, decode packet data from the receive signal, and then transfer the packet data to the MAC processor 804.

The MAC processor 804 includes a processor coupled to a memory that stores machine readable instructions, and the machine readable instructions, when executed by the processor, cause the processor to perform acts corresponding to MAC layer protocol operations, according to an embodiment. Additionally or alternatively, the MAC processor 804 includes a hardware state machine that performs acts corresponding to MAC layer protocol operations, according to another embodiment.

The PHY processor 808 includes components such as filters, a digital-to-analog converter (DAC), an analog-to-digital converter (ADC), amplifiers, etc. The PHY processor 808 also includes a hardware state machine configured to control the PHY processor 808 to perform acts corresponding to PHY protocol operations, according to an embodiment. Additionally or alternatively, the PHY processor 808 includes a processor coupled to a memory that stores machine readable instructions, and the machine readable instructions, when executed by the processor, cause the processor to perform acts corresponding to PHY protocol operations, according to another embodiment.

The PHY processor 808 includes the memories 116, 120 discussed above. Additionally, the PHY processor 808 includes the counter 140 discussed above. In an embodiment, the PHY processor 808 includes the network quieting controller 160. The network quieting controller 160 includes a hardware state machine that performs acts corresponding to quieting transmissions such as described herein, in an embodiment. Additionally or alternatively, the network quieting controller 160 includes a processor coupled to a memory that stores machine readable instructions, and the machine readable instructions, when executed by the processor, cause the processor to perform acts corresponding to quieting transmissions such as described herein, in another embodiment. In some embodiments, the network quieting controller 160 is separate from the PHY processor 808.

In some embodiments, the PHY processor 808 includes circuitry configured to perform signal level measurements regarding the shared communication medium 104. In other embodiments, the PHY processor 808 additionally or alternatively includes circuitry configured to perform power level measurements regarding the shared communication medium 104. In other embodiments, the PHY processor 808 additionally or alternatively includes circuitry configured to perform echo measurements regarding the shared communication medium 104.

The time-sensitive communication controller 164 is coupled to the MAC processor 804. The time-sensitive communication controller 164 generates messages (e.g., PTP messages or other suitable messages) and provides the messages to the MAC processor 804 for transmission via the communication medium 104. Additionally, the time-sensitive communication controller 164 receives messages (e.g., PTP messages or other suitable messages) from the MAC processor 804, the messages having been received via the communication medium 104.

In some embodiments, the time-sensitive communication controller 164 is omitted.

Embodiment 1: A method for time-sensitive communications in a communication network that operates according to a communication protocol, the method comprising: determining, at a coordinator communication device, that a time period is to begin during which only the coordinator communication device will have opportunities to transmit, the time period comprising a plurality of time cycles, each time cycle i) beginning with the coordinator communication device transmitting a beacon signal and ii) including a transmit opportunity that follows the beacon signal, the transmit opportunity for the coordinator communication device; transmitting, by the coordinator communication device, one or more signals to follower communication devices to prompt the follower communication devices to refrain from transmitting during the time period; and transmitting, by the coordinator communication device, one or more time-sensitive packets during one or more transmit opportunities of the time period.

Embodiment 2: The method of embodiment 1, wherein: the communication protocol specifies that i) the coordinator communication device is to transmit a beacon signal to signal a respective start of each first time cycle, and ii) the coordinator communication device has a respective initial first transmit opportunity in each first time cycle that immediately follows the beacon signal; and transmitting the one or more signals to prompt the follower communication devices to refrain from transmitting during the time period comprises, for each of multiple transmit opportunities during the time period, transmitting, by the coordinator communication device, a subsequent beacon signal immediately following the transmit opportunity.

Embodiment 3: The method of embodiment 2, wherein: the communication protocol further specifies that, for each first time cycle, i) each communication device in the communication network is given a respective first transmit opportunity during the first time cycle, and ii) after all communication devices in the communication network have had transmit opportunities in the first time cycle, the coordinator communication device is to transmit a next beacon signal to signal a start of a next first time cycle; and the method further comprises: maintaining, at the coordinator communication device, a parameter that indicates a number of communication devices in the communication network, and in connection with the time period, setting, at the coordinator communication device, the parameter to indicate that there is only one communication device in the communication network.

Embodiment 4: The method of embodiment 3, wherein the follower communication devices maintain respective other parameters that indicates the number of communication devices in the communication network, and wherein transmitting the one or more signals to prompt the follower communication devices to refrain from transmitting during the time period further comprises: in connection with the time period, transmitting, by the coordinator communication device, a packet that prompts the follower communication devices to set the respective parameters of the follower communication devices to indicate that there is only one communication device in the communication network.

Embodiment 5: The method of any of embodiments 1-4, wherein: the communication protocol specifies that, for each first time cycle, i) each communication device in the communication network is given a respective first transmit opportunity during the first time cycle, and ii) after all communication devices in the communication network have had transmit opportunities in the first time cycle, the coordinator communication device is to transmit a next beacon signal to signal a start of a next first time cycle; the follower communication devices maintain respective parameters that indicate a number of communication devices in the communication network; and transmitting the one or more signals to prompt the follower communication devices to refrain from transmitting during the time period comprises: in connection with the time period, transmitting, by the coordinator communication device, a packet that prompts the follower communication devices to set the respective parameters of the follower communication devices to indicate that there is only one communication device in the communication network.

Embodiment 6: The method of embodiment any of embodiments 1-5, further comprising: waiting, at the coordinator communication device, for the coordinator communication device to transmit at least two beacon signals during the time period; and beginning transmission, by the coordinator communication device, of the one or more time-sensitive packets during the time period only after waiting for the coordinator communication device to transmit the at least two beacon signals during the time period.

Embodiment 7: The method of embodiment 6, further comprising: determining, at the coordinator communication device, a number of beacon signals to transmit during the time period before beginning transmission of the one or more time-sensitive packets during the time period, wherein the number of beacon signals is at least two; and beginning transmission, by the coordinator communication device, of the one or more time-sensitive packets during the time period only after transmitting the number of beacon signals during the time period.

Embodiment 8: The method of embodiment any of embodiments 1-7, wherein transmitting the one or more time-sensitive packets comprises: transmitting, during one of the transmit opportunities, a packet that includes a timestamp that indicates a time of a clock of the coordinator communication device at which the packet was transmitted by the coordinator communication device.

Embodiment 9: The method of embodiment 8, wherein transmitting the packet that includes the timestamp comprises: transmitting the packet that includes the timestamp to facilitate the follower communication devices synchronizing respective clocks of the follower communication devices to the clock of the coordinator communication device.

Embodiment 10: The method of embodiment 9, wherein transmitting the packet that includes the timestamp comprises: transmitting a sync message defined by the Precision Time Protocol (PTP) to facilitate the follower communication devices synchronizing the respective clocks of the follower communication devices to the clock of the coordinator communication device.

Embodiment 11: The method of embodiment any of embodiments 1-11, wherein the communication protocol defines repeating first time cycles and specifies that each of multiple communication devices is provided a respective first transmit opportunity in each first time cycle; and the time period comprises a plurality of second time cycles, each second time cycle including a second transmit opportunity that follows the beacon signal.

Embodiment 12: A network interface device for communicating in a communication network that operates according to a communication protocol, the network interface device being configured to operate as a coordinator communication device and comprising: transmit circuitry; and controller circuitry that is configured to: determine that a time period is to begin during which only the coordinator communication device will have opportunities to transmit, the time period comprising a plurality of time cycles, each time cycle i) beginning with the coordinator communication device transmitting a beacon signal and ii) including a transmit opportunity that follows the beacon signal, the transmit opportunity for the coordinator communication device, control the transmit circuitry to transmit one or more signals to follower communication devices to prompt the follower communication devices to refrain from transmitting during the time period, and control the transmit circuitry to transmit one or more time-sensitive packets during one or more transmit opportunities of the time period.

Embodiment 13: The network interface device of embodiment 12, wherein: the communication protocol specifies that i) the coordinator communication device is to transmit a beacon signal to signal a respective start of each first time cycle, and ii) the coordinator communication device has a respective initial first transmit opportunity in each first time cycle that immediately follows the beacon signal; and the controller circuitry is configured to control the transmit circuitry to, for each of multiple transmit opportunities during the time period, transmit a subsequent beacon signal immediately following the transmit opportunity.

Embodiment 14: The network interface device of embodiment 13, wherein the controller circuitry includes a memory, and wherein: the communication protocol further specifies that, for each first time cycle, i) each communication device in the communication network is given a respective first transmit opportunity during the first time cycle, and ii) after all communication devices in the communication network have had transmit opportunities in the first time cycle, the coordinator communication device is to transmit a next beacon signal to signal a start of a next first time cycle; and the controller circuitry is configured to: maintain a parameter stored in the memory, the parameter indicating a number of communication devices in the communication network, and in connection with the time period, set the parameter to indicate that there is only one communication device in the communication network.

Embodiment 15: The network interface device of embodiment 14, wherein the follower communication devices maintain respective other parameters that indicates the number of communication devices in the communication network, and wherein the controller is further configured to: in connection with the time period, control the transmit circuitry to transmit a packet that prompts the follower communication devices to set the respective parameters of the follower communication devices to indicate that there is only one communication device in the communication network.

Embodiment 16: The network interface device of any of embodiments 12-15, wherein: the communication protocol specifies that, for each first time cycle, i) each communication device in the communication network is given a respective first transmit opportunity during the first time cycle, and ii) after all communication devices in the communication network have had transmit opportunities in the first time cycle, the coordinator communication device is to transmit a next beacon signal to signal a start of a next first time cycle; the follower communication devices maintain respective parameters that indicate a number of communication devices in the communication network; and control the transmit circuitry to transmit, in connection with the time period, a packet that prompts the follower communication devices to set the respective parameters of the follower communication devices to indicate that there is only one communication device in the communication network.

Embodiment 17: The network interface device of any of embodiments 12-16, wherein the controller is further configured to: wait for the transmit circuitry to transmit at least two beacon signals during the time period; and control the transmit circuitry to begin transmission of the one or more time-sensitive packets during the time period only after the transmit circuitry transmits the at least two beacon signals during the time period.

Embodiment 18: The network interface device of embodiment 17, wherein the controller is further configured to: determine a number of beacon signals that the transmit circuitry is to transmit during the time period before beginning transmission of the one or more time-sensitive packets during the time period, wherein the number of beacon signals is at least two; and control the transmit circuitry to begin transmission of the one or more time-sensitive packets during the time period only after the transmit circuitry transmits the number of beacon signals during the time period.

Embodiment 19: The network interface device of any of embodiments 12-18, wherein the network interface further comprises a clock, and wherein the controller is further configured to: control the transmit circuitry to transmit a packet that includes a timestamp that indicates a time of the clock of the coordinator communication device at which the packet was transmitted by the coordinator communication device.

Embodiment 20: The network interface device of embodiment 19, wherein the controller is further configured to: control the transmit circuitry to transmit the packet that includes the timestamp to facilitate the follower communication devices synchronizing respective clocks of the follower communication devices to the clock of the coordinator communication device.

Embodiment 21: The network interface device of embodiment 20, wherein the network interface further comprises a Precision Time Protocol (PTP) controller, and wherein the controller is further configured to: control the transmit circuitry to transmit a sync message from the PTP controller, the sync message defined by the PTP to facilitate the follower communication devices synchronizing the respective clocks of the follower communication devices to the clock of the coordinator communication device.

Embodiment 22: The network interface device of any of embodiments 12-21, wherein the communication protocol defines repeating first time cycles and specifies that each of multiple communication devices is provided a respective first transmit opportunity in each first time cycle; and the time period comprises a plurality of second time cycles, each second time cycle including a second transmit opportunity that follows the beacon signal.

Some of the various blocks, operations, and techniques described above may be implemented utilizing hardware, a processor executing firmware instructions, a processor executing software instructions, or any suitable combination thereof. When implemented utilizing a processor executing software or firmware instructions, the software or firmware instructions may be stored in any suitable computer readable memory. The software or firmware instructions may include machine readable instructions that, when executed by one or more processors, cause the one or more processors to perform various acts such as described above.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A method for time-sensitive communications in a communication network that operates according to a communication protocol, the communication protocol defining repeating first time cycles, wherein the communication protocol specifies that each of multiple communication devices is provided a respective first transmit opportunity in each first time cycle, the method comprising:
determining, at a coordinator communication device, that a time period is to begin during which only the coordinator communication device will have opportunities to transmit, the time period comprising a plurality of second time cycles, each second time cycle i) beginning with the coordinator communication device transmitting a beacon signal and ii) including a second transmit opportunity that follows the beacon signal, the second transmit opportunity for the coordinator communication device;
transmitting, by the coordinator communication device, one or more signals to follower communication devices to prompt the follower communication devices to refrain from transmitting during the time period; and
transmitting, by the coordinator communication device, one or more time-sensitive packets during one or more second transmit opportunities of the time period.

2. The method of claim 1, wherein:
the communication protocol specifies that i) the coordinator communication device is to transmit a beacon signal to signal a respective start of each first time cycle, and ii) the coordinator communication device has a respective initial first transmit opportunity in each first time cycle that immediately follows the beacon signal; and
transmitting the one or more signals to prompt the follower communication devices to refrain from transmitting during the time period comprises, for each of multiple second transmit opportunities during the time period, transmitting, by the coordinator communication device, a subsequent beacon signal immediately following the second transmit opportunity.

3. The method of claim 2, wherein:
the communication protocol further specifies that, for each first time cycle, i) each communication device in the communication network is given a respective first transmit opportunity during the first time cycle, and ii) after all communication devices in the communication network have had transmit opportunities in the first time cycle, the coordinator communication device is to transmit a next beacon signal to signal a start of a next first time cycle; and
the method further comprises:
maintaining, at the coordinator communication device, a parameter that indicates a number of communication devices in the communication network, and
in connection with the time period, setting, at the coordinator communication device, the parameter to indicate that there is only one communication device in the communication network.

4. The method of claim 3, wherein the follower communication devices maintain respective other parameters that indicates the number of communication devices in the communication network, and wherein transmitting the one or more signals to prompt the follower communication devices to refrain from transmitting during the time period further comprises:
in connection with the time period, transmitting, by the coordinator communication device, a packet that prompts the follower communication devices to set the respective parameters of the follower communication devices to indicate that there is only one communication device in the communication network.

5. The method of claim 1, wherein:
the communication protocol specifies that, for each first time cycle, i) each communication device in the communication network is given a respective first transmit opportunity during the first time cycle, and ii) after all communication devices in the communication network have had transmit opportunities in the first time cycle, the coordinator communication device is to transmit a next beacon signal to signal a start of a next first time cycle;
the follower communication devices maintain respective parameters that indicate a number of communication devices in the communication network; and
transmitting the one or more signals to prompt the follower communication devices to refrain from transmitting during the time period comprises: in connection with the time period, transmitting, by the coordinator communication device, a packet that prompts the follower communication devices to set the respective parameters of the follower communication devices to indicate that there is only one communication device in the communication network.

6. The method of claim 1, further comprising:
waiting, at the coordinator communication device, for the coordinator communication device to transmit at least two beacon signals during the time period; and
beginning transmission, by the coordinator communication device, of the one or more time-sensitive packets during the time period only after waiting for the coordinator communication device to transmit the at least two beacon signals during the time period.

7. The method of claim 6, further comprising:
determining, at the coordinator communication device, a number of beacon signals to transmit during the time period before beginning transmission of the one or more time-sensitive packets during the time period, wherein the number of beacon signals is at least two; and
beginning transmission, by the coordinator communication device, of the one or more time-sensitive packets during the time period only after transmitting the number of beacon signals during the time period.

8. The method of claim 1, wherein transmitting the one or more time-sensitive packets comprises:
transmitting, during one of the second transmit opportunities, a packet that includes a timestamp that indicates a time of a clock of the coordinator communication device at which the packet was transmitted by the coordinator communication device.

9. The method of claim 8, wherein transmitting the packet that includes the timestamp comprises:
transmitting the packet that includes the timestamp to facilitate the follower communication devices synchronizing respective clocks of the follower communication devices to the clock of the coordinator communication device.

10. The method of claim 9, wherein transmitting the packet that includes the timestamp comprises:
transmitting a sync message defined by the Precision Time Protocol (PTP) to facilitate the follower communication devices synchronizing the respective clocks of the follower communication devices to the clock of the coordinator communication device.

11. A network interface device for communicating in a communication network that operates according to a communication protocol, the communication protocol defining repeating first time cycles, wherein the communication protocol specifies that each of multiple communication devices is provided a respective first transmit opportunity in each first time cycle, the network interface device being configured to operate as a coordinator communication device and comprising:
transmit circuitry; and
controller circuitry that is configured to:
determine that a time period is to begin during which only the coordinator communication device will have opportunities to transmit, the time period comprising a plurality of second time cycles, each second time cycle i) beginning with the coordinator communication device transmitting a beacon signal and ii) including a second transmit opportunity that follows the beacon signal, the second transmit opportunity for the coordinator communication device,
control the transmit circuitry to transmit one or more signals to follower communication devices to prompt the follower communication devices to refrain from transmitting during the time period, and
control the transmit circuitry to transmit one or more time-sensitive packets during one or more second transmit opportunities of the time period.

12. The network interface device of claim 11, wherein:
the communication protocol specifies that i) the coordinator communication device is to transmit a beacon signal to signal a respective start of each first time cycle, and ii) the coordinator communication device has a respective initial first transmit opportunity in each first time cycle that immediately follows the beacon signal; and
the controller circuitry is configured to control the transmit circuitry to, for each of multiple second transmit opportunities during the time period, transmit a subsequent beacon signal immediately following the second transmit opportunity.

13. The network interface device of claim 12, wherein the controller circuitry includes a memory, and wherein:
the communication protocol further specifies that, for each first time cycle, i) each communication device in the communication network is given a respective first transmit opportunity during the first time cycle, and ii) after all communication devices in the communication network have had transmit opportunities in the first time cycle, the coordinator communication device is to transmit a next beacon signal to signal a start of a next first time cycle; and
the controller circuitry is configured to:
maintain a parameter stored in the memory, the parameter indicating a number of communication devices in the communication network, and
in connection with the time period, set the parameter to indicate that there is only one communication device in the communication network.

14. The network interface device of claim 13, wherein the follower communication devices maintain respective other parameters that indicates the number of communication devices in the communication network, and wherein the controller is further configured to:
in connection with the time period, control the transmit circuitry to transmit a packet that prompts the follower communication devices to set the respective parameters of the follower communication devices to indicate that there is only one communication device in the communication network.

15. The network interface device of claim 11, wherein:
the communication protocol specifies that, for each first time cycle, i) each communication device in the communication network is given a respective first transmit opportunity during the first time cycle, and ii) after all communication devices in the communication network have had transmit opportunities in the first time cycle, the coordinator communication device is to transmit a next beacon signal to signal a start of a next first time cycle;
the follower communication devices maintain respective parameters that indicate a number of communication devices in the communication network; and
control the transmit circuitry to transmit, in connection with the time period, a packet that prompts the follower communication devices to set the respective parameters of the follower communication devices to indicate that there is only one communication device in the communication network.

16. The network interface device of claim 11, wherein the controller is further configured to:
wait for the transmit circuitry to transmit at least two beacon signals during the time period; and
control the transmit circuitry to begin transmission of the one or more time-sensitive packets during the time period only after the transmit circuitry transmits the at least two beacon signals during the time period.

17. The network interface device of claim 16, wherein the controller is further configured to:
determine a number of beacon signals that the transmit circuitry is to transmit during the time period before beginning transmission of the one or more time-sensitive packets during the time period, wherein the number of beacon signals is at least two; and
control the transmit circuitry to begin transmission of the one or more time-sensitive packets during the time period only after the transmit circuitry transmits the number of beacon signals during the time period.

18. The network interface device of claim 11, wherein the network interface further comprises a clock, and wherein the controller is further configured to:
control the transmit circuitry to transmit a packet that includes a timestamp that indicates a time of the clock of the coordinator communication device at which the packet was transmitted by the coordinator communication device.

19. The network interface device of claim 18, wherein the controller is further configured to:
control the transmit circuitry to transmit the packet that includes the timestamp to facilitate the follower communication devices synchronizing respective clocks of the follower communication devices to the clock of the coordinator communication device.

20. The network interface device of claim 19, wherein the network interface further comprises a Precision Time Protocol (PTP) controller, and wherein the controller is further configured to:
control the transmit circuitry to transmit a sync message from the PTP controller, the sync message defined by the PTP to facilitate the follower communication devices synchronizing the respective clocks of the follower communication devices to the clock of the coordinator communication device.
